(19) United States
(12) Patent Application Publication
(10) Pub. No.: US 2013/0115041 A1
(43) Pub. Date: May 9, 2013

(54) Method for lifting items from and upon trucks

(71) Applicants: Brett Taylor, St. Charles, MO (US); Kevin Noble, Wentzville, MO (US)

(72) Inventors: Brett Taylor, St. Charles, MO (US); Kevin Noble, Wentzville, MO (US)

(21) Appl. No.: 13/373,109

(22) Filed: Nov. 5, 2011

(51) Int. Cl. B60P 1/00; B23P 11/00; F16M 13/02

(52) U.S. Cl. 414/812; 248/674; 29/428

(57) ABSTRACT

A method enabling a single worker to safely lift a cargo item without personal injury that weighs up to four hundred pounds from and onto a truck platform is provided, and includes providing a one-piece hoist support member, configured to support a portable hand-held hoist, having a vertical post, a short offset cantilever beam permanently affixed to an upper portion of the vertical post, and a receiver stem affixed to a lower portion of the vertical post, which enables mounting and supporting the lifting device upon the truck The result is the elimination of the need to employ a more complex device, such as a hydraulic cylinder, for raising and lowering a pivoting boom for moving the cargo item up and down. The simplicity of this arrangement also facilitates sharing one lightweight portable lifting device between two or more trucks, which can be easily carried out by a single worker.

### BACKGROUND OF THE INVENTION

It is desirable to provide a method for enabling a single worker to lift cargo items that weigh up to 400 pounds, from and onto truck platforms without personal injury, and thus not need to call for providing two workers to manually lift such cargo items to deposit them on or off the truck platform. It is also desirable that the method utilizes a simple cargo lifting device not having complex moving parts and thus has a very low manufacturing cost. It is also deemed desirable that the cargo lifting device be lightweight and portable, and thus may be easily and quickly carried from one truck to another by one person, since virtually no labor is needed to remove it from a first truck and mount it upon a second truck. It is submitted that the prior art patents known to the inventors do not provide these attributes.

### SUMMARY OF A PREFERRED EMBODIMENT OF THE INVENTION

The above stated goals are met by providing a method for enabling a single worker to safety lift an item that weighs up to four hundred pounds from and onto a truck platform, the method including providing a one-piece hoist support member configured to support a portable widely available hand-held hoist, and having a vertical post, a short offset cantilever beam permanently rigidly affixed to an upper portion of the vertical post, rendering the vertical post and short offset cantilever beam non-movable with respect to each other, and where a receiver stem is affixed to a lower portion of the vertical post, which enables mounting and supporting the one-piece lifting device upon the truck in a manner whereby the vertical post and the short offset cantilever beam permanently lie in a fixed plane at all times when mounted upon the truck. The result is the elimination for the need to employ a device, such as a hydraulic cylinder, for raising and lowering a pivoting boom for moving a cargo item up and down. The simplicity of this arrangement also facilitates manually carrying one lightweight portable lifting device, between two or more trucks, that can be easily carried out by a single worker. The receiver is a class III receiver, attached to numerous types and styles of service and pickup trucks that need not employ a commonly used locking receiver pin.

### BRIEF DESCRIPTION OF THE DRAWINGS

FIG. 1 discloses a perspective view of a cargo item suspended by a widely available portable hoist and which is to be transported by actuation of the hoist between a truck platform and a ground support platform.

FIG. 2 discloses a receiver stem affixed to a lower portion of the vertical post and which is inserted into a class III truck receiver.

### DETAILED DESCRIPTION OF PREFERRED EMBODIMENTS OF THE INVENTION

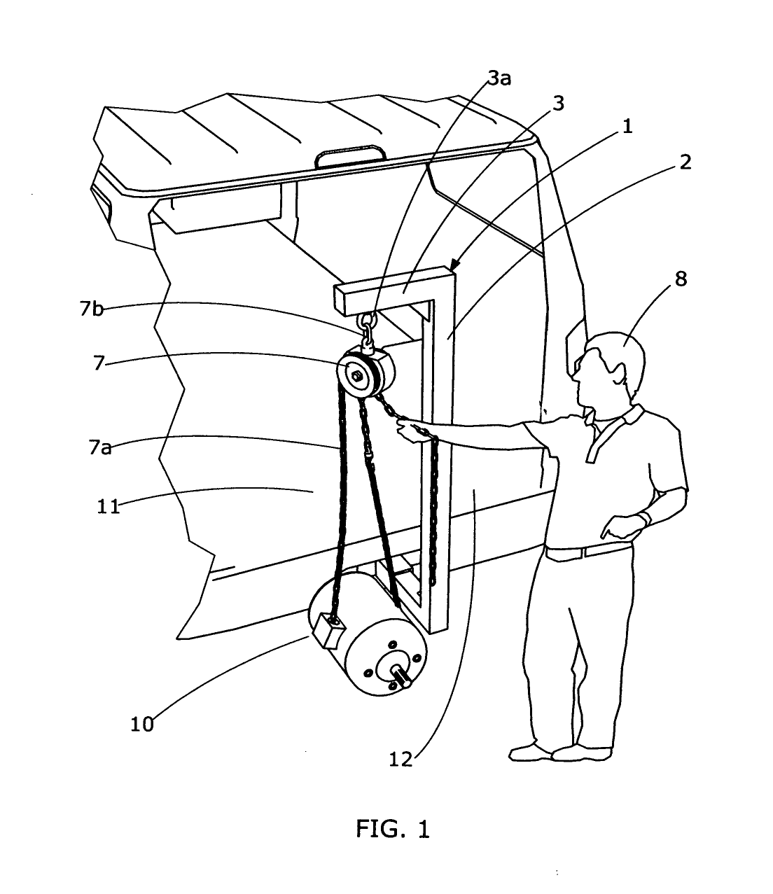

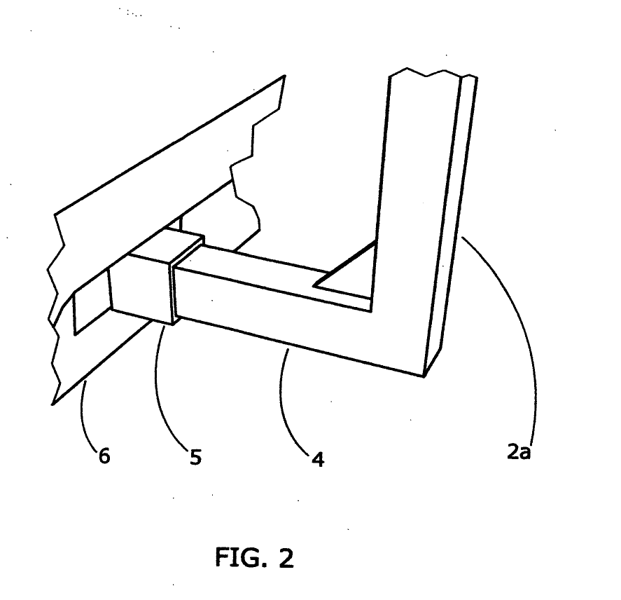

Referring to FIGS. 1 and 2, hoist support member 1 comprises a vertical post 2 permanently and non-movably welded to a short offset cantilever beam 3 at its upper portion as shown in FIG. 1. In FIG. 2, a receiver stem 4 is welded to a lower portion of vertical beam 2 at portion 2a and is perpendicular to the length of vertical post 2.

The receiver stem 4 is inserted into a widely used class III receiver 5, mounted upon a rear portion of a truck 6, which is commonly a standard panel van or a pick-up truck with tail gate removed.

When the worker inserts the receiver stem into the receiver he need not actuate a locking device such as a receiver pin to secure the receiver stem within the receiver. This is because the weight of the offset arm produces a position maintaining pitching moment within the receiver.

Worker 8 positions the portable hoist support member 1 upon the truck by inserting the receiver stem 4 into receiver 5 of the truck in a manner whereby the vertical post and the short offset cantilever beam permanently lie in a fixed plane at all times when mounted upon the truck. This aspect eliminates the need for beam motion devices supporting the cargo items for raising the cargo items up and down while moving them, thereby to save the manufacturing costs of cargo beam motion devices such as hydraulic cylinders.

The worker attaches the hand-held hoist 7 to the short offset cantilever beam 3 by means of hooks 3a and 7b of the cantilever beam and the hand-held hoist 7 respectively, and manipulates the chain 7a of the portable hoist 7 to attach itself to an item 10, that is positioned upon the truck platform 11, for removing the item from the truck platform and lowering the item to a ground-based support platform (not shown).

When the worker desires to lift a cargo item from a ground based support platform, the process is reversed so that chain 7a is attached to the cargo item and the hand-held hoist is actuated to lift the item onto the platform of the truck.

Thus, the method of the invention for lifting a cargo item from and onto a truck platform includes
(a) providing a novel hoist support member 1 configured to support a portable commercially available hand-held hoist 7 by means of hooks 3a and 7b, and having a vertical post 2 and a short offset cantilever beam 3 permanently and non-movably affixed to an upper portion of the vertical post and a receiver stem 4 affixed to a lower portion of the vertical post and
(b) positioning the hoist support member 1 upon the truck platform 12 by inserting the receiver stem 4 into a receiver 5 of the truck in a manner whereby the vertical post and the offset cantilever beam permanently lie in a fixed plane at all times when mounted upon the truck.

While the invention has been described in connection with preferred embodiments, the description is not intended to limit the scope of the invention to the particular forms set forth, but on the contrary, it is intended to cover such alternatives, modifications, and equivalents as may be included within the spirit and scope of the invention as indicated by the language of the appended claims.

The term “ground based support platform” is often a hand propelled wheeled support wagon or the like, but is intended to include the ground itself.

The term “receiver” is known in the art, see for example the abstract in Pacini Patent Application Publication US 2004/0234367 for “Combination Hoist and Trailer Hitch”.

The term “portable hoist” is intended to include a small widely commercially available general purpose portable hoist.

The term “truck” is intended to cover pickup trucks, vans, and panel vans.

What is claimed is:

1. A method for lifting a cargo item that weighs up to 400 pounds from and onto a truck having a truck platform comprising the steps of:
(a) providing a hoist support member, configured to support a portable commercially available hand-held hoist, and having a vertical post, and an offset cantilever beam permanently and non-movably affixed to an upper portion of said vertical post and a receiver stem affixed to a lower portion of said vertical post;
(b) positioning said hoist support member upon said truck by inserting the receiver stem into a receiver of the truck in a manner whereby said vertical post and said offset cantilever beam permanently lie in a first plane at all times when mounted upon the truck;
(c) attaching the hand-held hoist to said offset cantilever beam;
(d) manipulating the hand-held hoist at various times to attach the hand-held hoist to cargo items that are positioned upon said truck platform;
(e) removing said cargo items from the truck platform and lowering the cargo items to a ground-based support platform; and
(f) manipulating the hand-held hoist at various times to attach the hand-held hoist to cargo items that are positioned upon said ground-based support platform and lifting cargo items from the ground-based support platform up to the support platform of the truck.

2. The method of claim 1 including the step of removing the receiver stem from the receiver of the truck and carrying said hoist support member to another location.

3. The method of claim 2 including the step of inserting the receiver stem into a receiver of another truck, enabling a single hoist support member to be used on a plurality of trucks.

4. The method of claim 1 wherein said receiver is a class III receiver that need not employ a locking pin.

5. The method of claim 2 wherein said receiver is a class III receiver that need not employ a locking pin.

6. The method of claim 3 wherein said receiver is a class III receiver that need not employ a locking pin.

7. A hoist support member configured to support a portable commercially available hand-held hoist and having a vertical post and a offset cantilever beam permanently and non-movably affixed to an upper portion of the vertical post and a receiver stem affixed to a lower portion of the vertical post and wherein the hoist support member is supported upon the truck platform when the receiver stem is positioned within said receiver of the truck in a manner whereby the vertical post and the offset cantilever beam permanently lie in a fixed plane at all times when mounted upon the truck.

8. The hoist support member of claim 7 wherein the receiver stem is substantially perpendicular with respect to the length of the vertical post.

9. The hoist support member of claim 7 wherein the vertical post and the offset cantilever beam are welded together.

10. The hoist support member of claim 8 wherein the vertical post and the offset cantilever beam are welded together.

11. The hoist support member of claim 7 wherein the hoist support member is light enough to be carried by a single person.

12. The hoist support member of claim 8 wherein the hoist support member is light enough to be carried by a single person.

13. The hoist support member of claim 7 wherein the length of the offset cantilever beam is substantially less than the length of the vertical post and wherein said receiver need not employ a locking pin.

14. The hoist support member of claim 8 wherein the length of the offset cantilever beam is substantially less than the length of the vertical post and wherein said receiver need not employ a locking pin.

15. A method enabling a single worker to lift a cargo item that weighs up to 400 pounds from and onto a truck platform comprising the steps of:
(a) providing a hoist support member, configured to support a portable commercially available hand-held hoist, and having a vertical post and an offset cantilever beam permanently and non-movably affixed to an upper portion of said vertical post and a receiver stem affixed to a lower portion of said vertical post;
(b) positioning said hoist support member upon said truck by inserting the receiver stem into a receiver of the truck in a manner whereby said vertical post and said offset cantilever beam permanently lie in a first fixed plane at all times when mounted upon the truck; and
(c) attaching a hand-held hoist to the offset cantilever beam.

16. The hoist support member of claim 15 wherein the receiver stem lies in a second plane substantially perpendicular with respect to the first plane and wherein said receiver need not employ a locking pin.

17. The hoist support member of claim 15 wherein the vertical post, and the short offset cantilever beam are welded together.

18. The hoist support member of claim 16 wherein the vertical post, and the short offset cantilever beam are welded together.

19. The hoist support member of claim 15 wherein the hoist support member is light enough to be carried by a single person.

20. The hoist support member of claim 16 wherein the hoist support member is light enough to be carried by a single person.
